(19) United States
(12) Patent Application Publication
(10) Pub. No.: US 2012/0013207 A1
(43) Pub. Date: Jan. 19, 2012

(54) STATOR SLEEVE FOR AN ELECTRIC MACHINE AND METHOD OF ESTABLISHING A COOLANT CAVITY ABOUT A STATOR FOR AN ELECTRIC MACHINE

(75) Inventors: Bradley D. Chamberlin, Pendleton, IN (US); Alex Creviston, Muncie, WI (US)

(73) Assignee: REMY TECHNOLOGIES, L.L.C., Pendleton, IN (US)

(21) Appl. No.: 13/172,406

(22) Filed: Jun. 29, 2011

Related U.S. Application Data
(60) Provisional application No. 61/363,872, filed on Jul. 13, 2010.

(51) Int. Cl. H02K 5/20; H02K 15/00

(52) U.S. Cl. 310/59; 310/64; 29/596

(57) ABSTRACT

An electric machine including a housing, and a stator mounted within the housing. The stator includes an outer perimetric surface and an inner perimetric surface. A rotor is mounted, at least in part, within the inner perimetric surface of the stator. The rotor is rotatable relative to the stator. A stator sleeve extends about the stator. The stator sleeve includes a first sleeve portion and a second sleeve portion. The first sleeve portion includes a first diametric edge that extends to a second diametric edge, and the second sleeve portion includes a first diametric edge section that extends to a second diametric edge section. The stator sleeve is configured and disposed to establish a coolant cavity about the outer perimetric surface of the stator.

### CROSS REFERENCE TO RELATED APPLICATIONS

This application claims the benefit of U.S. Provisional Application No. 61/363,872 filed Jul. 13, 2010, the contents of which are incorporated by reference herein in their entirety.

### BACKGROUND OF THE INVENTION

Exemplary embodiments pertain to the art of electric machines and, more particularly, to a stator sleeve for an electric machine.

Many electric machines, such as electric motors, include a stator and a rotor. The rotor spins relative to the stator in response to an electrical current. The electrical current passing through the rotor and stator creates heat. It is desirable to remove the heat in order to enhance motor performance. In some cases, the heat is removed by passing air currents across and through the motor. In other cases, oil is passed through the electric motor in proximity to the stator. The oil flows through passages formed in a motor housing adjacent the stator. In still other cases, in particular when the motor does not include a housing, coolant is passed through passages formed in the stator. Regardless, removal of heat from the stator and/or rotor contributes to enhanced performance for the electric motor.

### BRIEF DESCRIPTION OF THE INVENTION

Disclosed is an electric machine including a housing, and a stator mounted within the housing. The stator includes an outer perimetric surface and an inner perimetric surface. A rotor is mounted, at least in part, within the inner perimetric surface of the stator. The rotor is rotatable relative to the stator. A stator sleeve extends about the stator. The stator sleeve includes a first sleeve portion and a second sleeve portion. The first sleeve portion includes a first diametric edge that extends to a second diametric edge, and the second sleeve portion includes a first diametric edge section that extends to a second diametric edge section. The stator sleeve is configured and disposed to establish a coolant cavity about the outer perimetric surface of the stator.

Also disclosed is a method of forming a coolant cavity about a stator of an electric machine. The method includes mounting a stator sleeve including a first sleeve portion and a second sleeve portion about an outer perimetric surface of a stator, inserting the stator sleeve into an interior portion of an electric machine housing, and establishing a coolant cavity about an outer perimetric surface of the stator between the stator sleeve and the housing.

### BRIEF DESCRIPTION OF THE DRAWINGS

The following descriptions should not be considered limiting in any way. With reference to the accompanying drawings, like elements are numbered alike:

FIG. 1 is a partial, cross-sectional view of an electric machine including a stator sleeve in accordance with an exemplary embodiment;

FIG. 2 is a partial, perspective view of the stator sleeve of FIG. 1 positioned about an outer perimetric surface of a stator in accordance with an exemplary embodiment;

FIG. 3 is an exploded view of the stator sleeve and stator of FIG. 2;

FIG. 4 is a partial, cross-sectional view of the electric machine including a stator sleeve in accordance with another aspect of the exemplary embodiment;

FIG. 5 is a partial, perspective view of the stator sleeve of FIG. 4 positioned about an outer perimetric surface of a stator in accordance with an exemplary embodiment;

FIG. 6 is a partial, cross-sectional view of the electric machine including a stator sleeve in accordance with still another aspect of the exemplary embodiment; and

FIG. 7 is a partial, perspective view of the stator sleeve of FIG. 6 positioned about an outer perimetric surface of a stator in accordance with an exemplary embodiment.

### DETAILED DESCRIPTION OF THE INVENTION

A detailed description of one or more embodiments of the disclosed apparatus and method are presented herein by way of exemplification and not limitation with reference to the Figures.

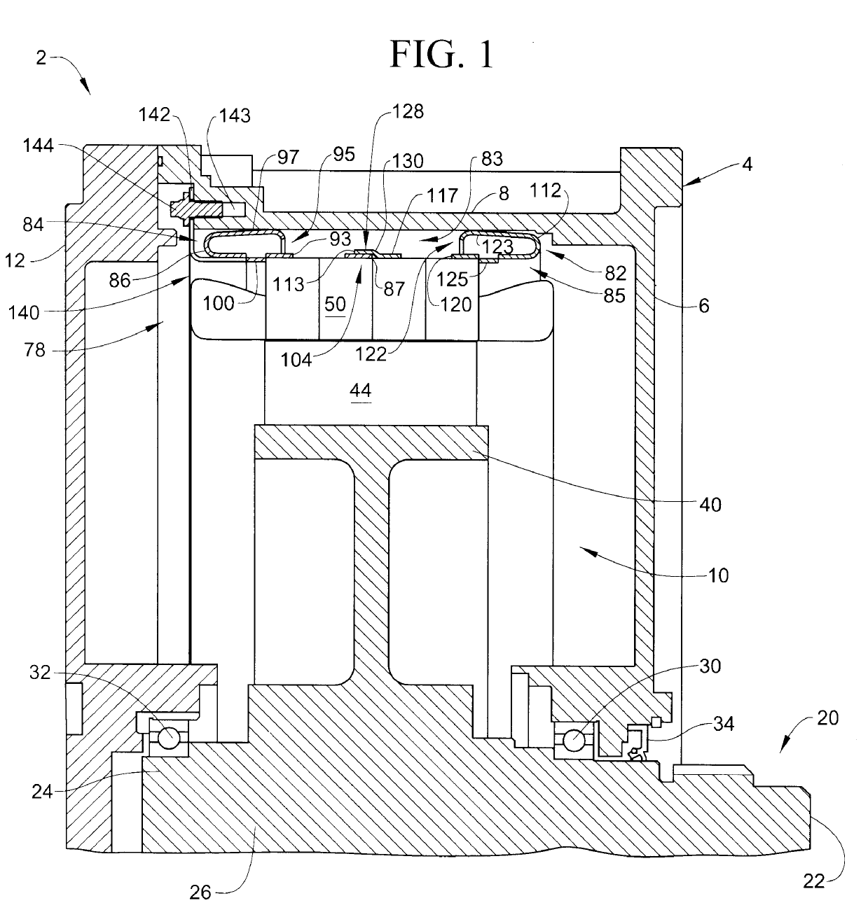

An electric machine constructed in accordance with an exemplary embodiment is indicated generally at 2 in FIG. 1. Electric machine 2 takes the form of an electric motor having housing 4 including a first end wall 6 that is joined with a first side wall 8 and an opposing second side wall (not shown) that form an interior portion 10. A second, detachable, end wall 12 is secured to first side wall 8 and a second side wall (not shown). Second end wall 12 serves as a cover that provides access to interior portion 10. Electric machine 2 includes a shaft 20 that establishes an axial axis or direction of electrical machine 2. A radial axis or direction extends perpendicularly to the axial axis. Shaft 20 includes a first end 22 that extends through first end wall 6 to a second end 24 through an intermediate portion 26. First end 22 is rotatably supported relative to first end wall 6 through a first bearing 30 and second end 24 is rotatably supported relative to second end wall 12 through a second bearing 32. A seal 34 extends about first end 22 at first end wall 6. Seal 34 is provided to contain any fluid, such as lubricant and/or coolant present within interior portion 10. Shaft 20 rotatably supports a hub 40 which, in turn, supports a rotor 44. Rotor 44 rotates relative to a stator 50 that is supported relative to housing 4.

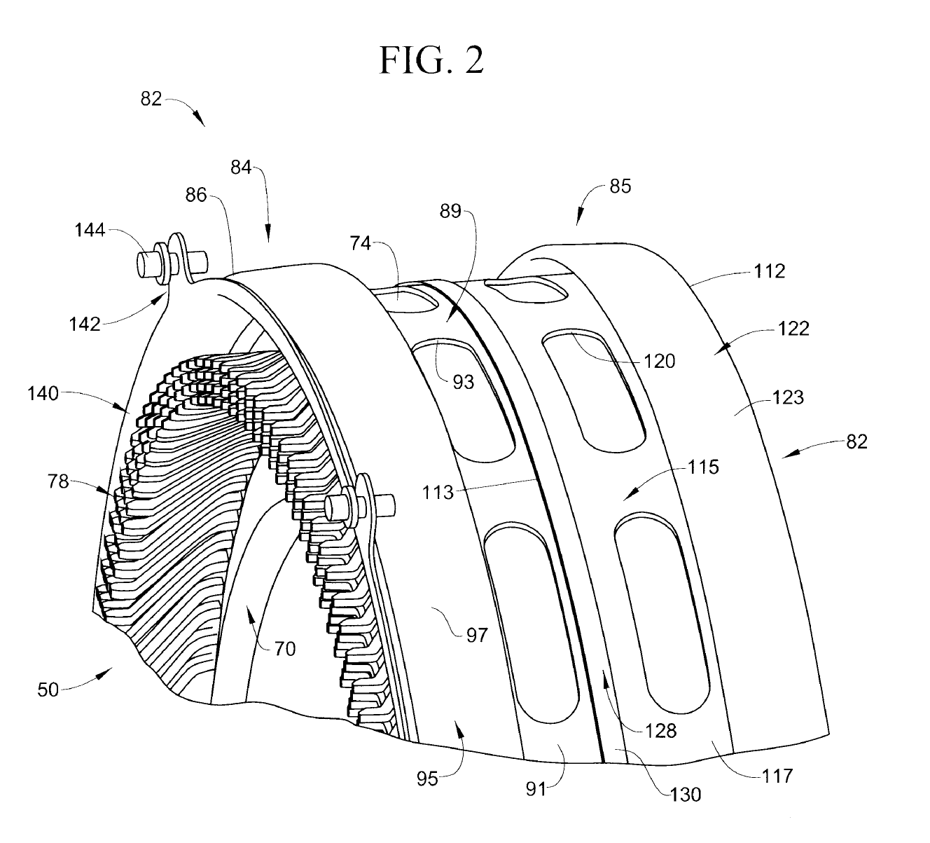

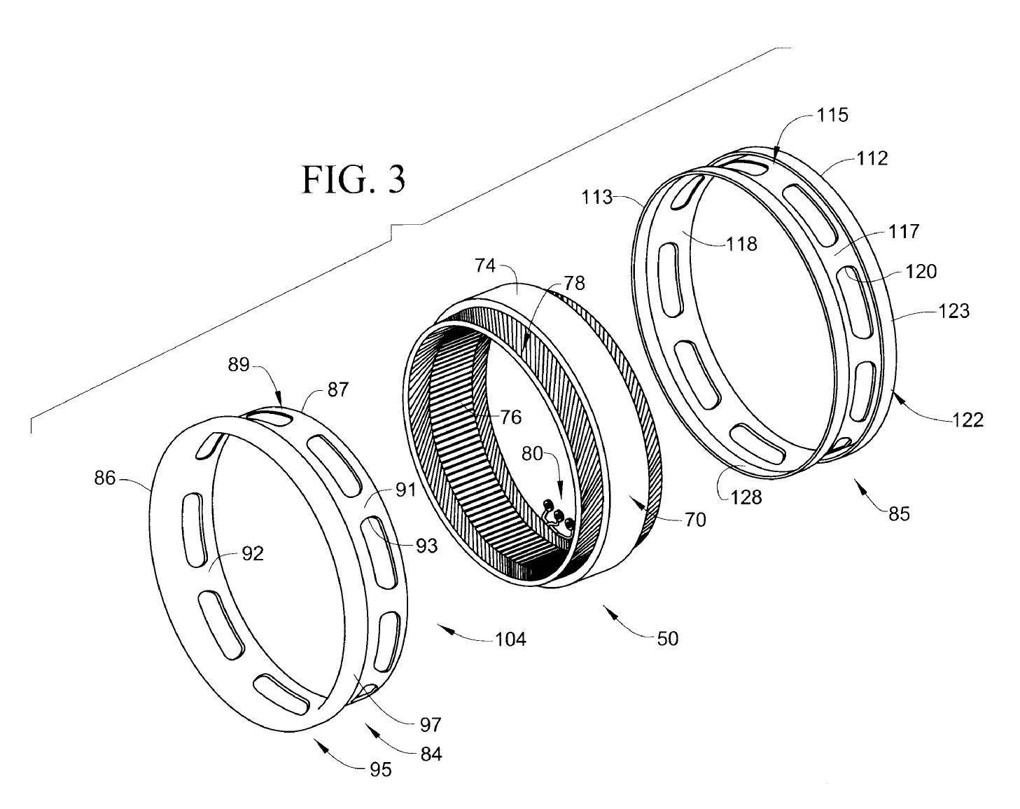

As best shown in FIGS. 2-3 stator 50 includes a body member 70 formed from a plurality of laminations (not separately labeled). Body member 70 includes an outer perimetric surface 74 and an inner perimetric surface 76. Stator 50 includes a plurality of windings 78 that are mounted to body member 70. Windings 78 include a plurality of terminals 80 that are configured to be connected to an external electric supply. Of course, it should be understood that terminals 80 could also be connected to an electrical device if electric machine 2 is operated as a generator. In accordance with an exemplary embodiment, electric machine 2 includes a stator sleeve 82 that positions stator 50 within interior portion 10 and establishes a coolant cavity 83 between stator 50 and housing 4 in a manner that will become more readily apparent below.

In accordance with one aspect of the exemplary embodiment, stator sleeve 82 includes a first sleeve portion 84 and a second sleeve portion 85. First sleeve portion 84 includes a first diametric edge 86 that extends to a second diametric edge 87 through an intermediate portion 89. Intermediate portion 89 includes an outer diametric surface 91 and an opposing inner diametric surface 92. Intermediate portion 89 is also shown to include a plurality of openings, one of which is indicated at 93, that facilitate contact between coolant (not shown) passing through coolant cavity 83 and body member 70. First sleeve portion 84 includes an interface member 95 that extends from outer diametric surface 91 at first diametric edge 86. Interface member 95 includes a cantilevered section 97 that establishes a resilient interface between stator 50 and housing 4. First sleeve portion 84 is also shown to include a locating member 100. Locating member 100 takes the form of a shoulder (not separately labeled) formed in inner diametric surface 92 that establishes a desired position of first sleeve portion 84 relative to stator 50. First sleeve portion 84 is also shown to include a mounting member 104 which, in the exemplary aspect shown, takes the form of second diametric edge 87. As will be detailed more fully below, mounting member 104 provides an interface to second sleeve portion 85.

Second sleeve portion 85 includes a first diametric edge section 112 that extends to a second diametric edge section 113 through an intermediate section 115. Intermediate section 115 includes an outer diametric surface 117 and an opposing inner diametric surface 118. Intermediate section 115 is also shown to include a plurality of openings, one of which is indicated at 120, that facilitate contact between coolant (not shown) passing through coolant cavity 83 and body member 70. Second sleeve portion 85 includes an interface member 122 that extends from outer diametric surface 117 at first diametric edge 112. Interface member 122 includes a cantilevered section 123 that establishes a resilient interface between stator 50 and housing 4. Second sleeve portion 85 is also shown to include a locating element 125. Locating element 125 takes the form of a shoulder (not separately labeled) formed in inner diametric surface 118 that establishes a desired position of second sleeve portion 85 relative to stator 50. Second sleeve portion 85 is also shown to include a mounting element 128 that takes the form of a flange 130.

Mounting element 128 interfaces with mounting member 104 to provide an interface between first and second sleeve portions 84 and 85. More specifically, first sleeve portion 84 is mounted to stator 50 such as by an interference fit with outer perimetric surface 74 of body member 70. Once first sleeve portion 84 is seated with locating member 100 abutting body member 70, second sleeve portion 85 is mounted to stator 50. Second sleeve portion 85 is also secured through, for example, an interference fit with outer perimetric surface 74 of body member 70. When second sleeve portion 85 is fully seated with locating element abutting body member 70, flange 130 receives mounting member 104. Once stator sleeve 82 is mounted, stator 50 is installed into interior portion 10. When installed, interface members 95 and 122 exert a substantially uniform radial force that establishes a desired position of stator 50 relative to housing 4. In the exemplary embodiment shown, interface members 95 and 122 resiliently bias stator 50 toward a center of housing 4. Interface member 95 and 122 also create coolant cavity 83. At this point, a flange member 140 is positioned within first sleeve portion 84 and secured to housing 4. Flange member 140 includes a plurality of mounting sections, one of which is indicated at 142 that align with corresponding mounting portions, such as shown at 143 in FIG. 1, and secured by mechanical fasteners 144. With this arrangement, stator sleeve 82 establishes a radial position of stator 50 while flange member 140 constrains stator 50 in the axial direction.

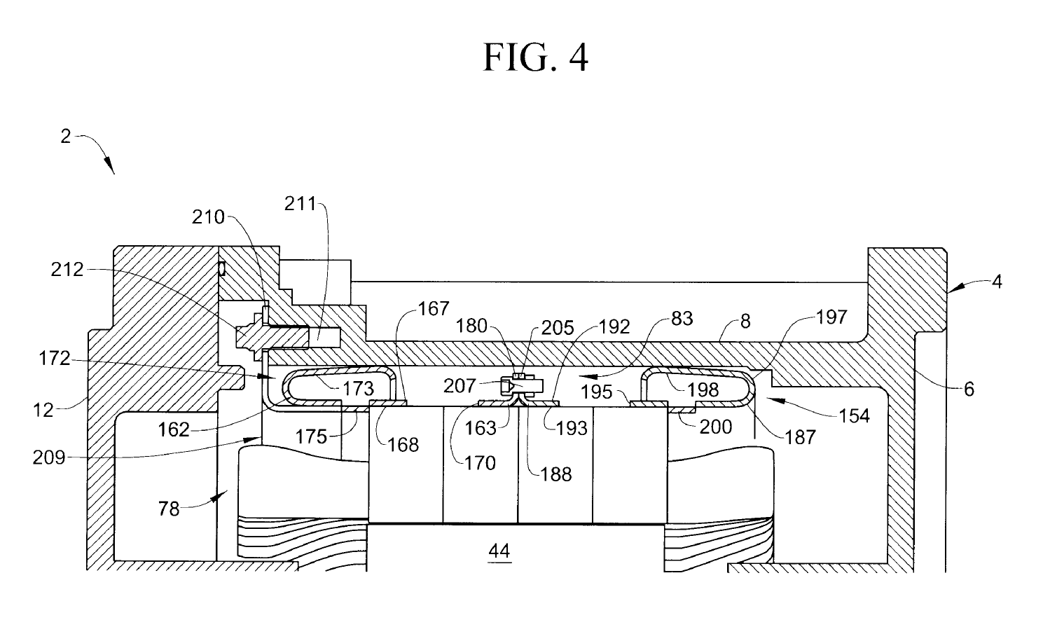

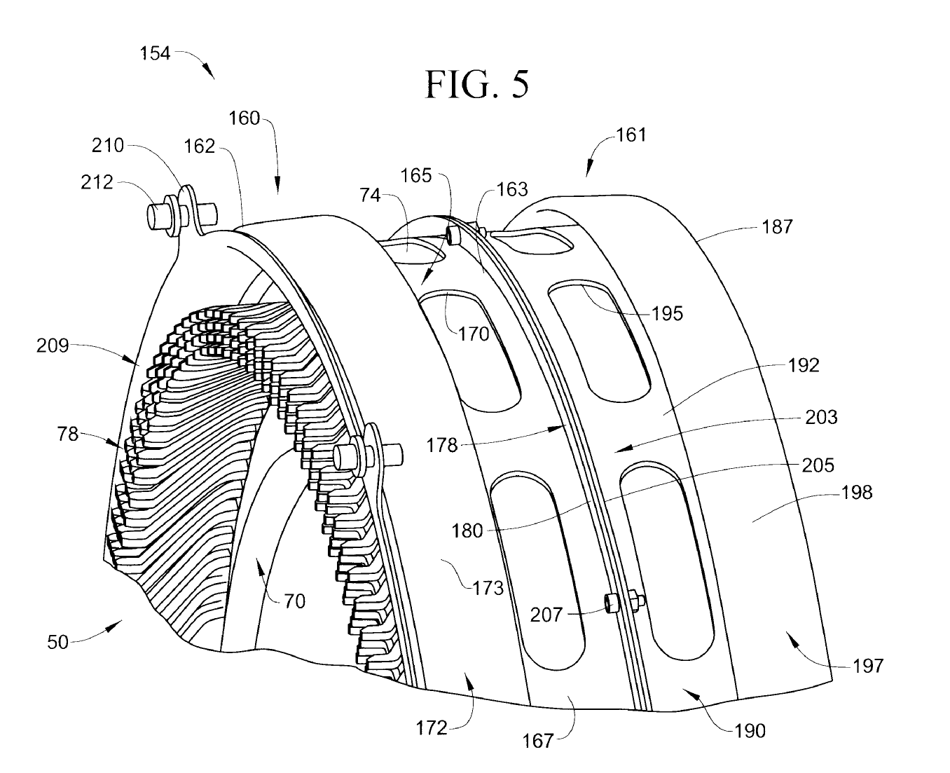

Reference will now be made to FIGS. 4-5, wherein like reference numbers represent corresponding parts in the respective views in describing a stator sleeve 154 constructed in accordance with another aspect of the exemplary embodiment. Stator sleeve 154 includes a first sleeve portion 160 and a second sleeve portion 161. First sleeve portion 160 includes a first diametric edge 162 that extends to a second diametric edge 163 through an intermediate portion 165. Intermediate portion 165 includes an outer diametric surface 167 and an opposing inner diametric surface 168. Intermediate portion 165 is also shown to include a plurality of openings, one of which is indicated at 170, that facilitate contact between coolant (not shown) passing through coolant cavity 83 and body member 70. First sleeve portion 160 includes an interface member 172 that extends from outer diametric surface 167 at first diametric edge 162. Interface member 172 includes a cantilevered section 173 that establishes a resilient interface between stator 50 and housing 4. First sleeve portion 160 is also shown to include a locating member 175. Locating member 175 takes the form of a shoulder (not separately labeled) formed in inner diametric surface 168 that establishes a desired position of first sleeve portion 160 relative to stator 50. First sleeve portion 160 is further shown to include a mounting member 178 which, in the exemplary aspect shown, takes the form of a flange member 180. In a manner similar to that described above, mounting member 178 provides an interface to second sleeve portion 161.

Second sleeve portion 185 includes a first diametric edge section 187 that extends to a second diametric edge section 188 through an intermediate section 190. Intermediate section 190 includes an outer diametric surface 192 and an opposing inner diametric surface 193. Intermediate section 190 is also shown to include a plurality of openings, one of which is indicated at 195, that facilitate contact between coolant (not shown) passing through coolant cavity 83 and body member 70. Second sleeve portion 185 includes an interface member 197 that extends from outer diametric surface 192 at first diametric edge 161. Interface member 197 includes a cantilevered section 198 that establishes a resilient interface between stator 50 and housing 4. Second sleeve portion 161 is also shown to include a locating element 200. Locating element 200 takes the form of a shoulder (not separately labeled) formed in inner diametric surface 193 that establishes a desired position of second sleeve portion 187 relative to stator 50. Second sleeve portion 161 is also shown to include a mounting element 203 that takes the form of a flange element 205.

Flange element 205 interfaces with flange member 180 to provide an interface between first and second sleeve portions 160 and 161. More specifically, first sleeve portion 160 is mounted to stator 50 such as by an interference fit with outer perimetric surface 74 of body member 70. Once first sleeve portion 160 is seated with locating member 175 abutting body member 70, second sleeve portion 185 is mounted to stator 50. Second sleeve portion 161 is also secured through, for example, an interference fit with outer perimetric surface 74 of body member 70. When second sleeve portion 161 is fully seated with locating element 200 abutting body member 70, flange member 180 aligns with flange element 205. Once aligned, mechanical fasteners, one of which is indicated at 207, are employed to join first sleeve portion 160 and second sleeve portion 161. Once stator sleeve 154 is mounted, stator 50 is installed into interior portion 10. When installed, interface members 172 and 197 exert a substantially uniform radial force that establishes a desired position of stator 50 relative to housing 4. In the exemplary embodiment shown, interface members 172 and 197 resiliently bias stator 50 toward a center of housing 4. Interface members 172 and 197 also create coolant cavity 83. At this point, a flange member 209 is positioned within first sleeve portion 160 and secured to housing 4. Flange member 209 includes a plurality of mounting sections, one of which is indicated at 210, which align with corresponding mounting portions, such as shown at 211 in FIG. 4, and secured by mechanical fasteners 212. With this arrangement, stator sleeve 154 establishes a radial position of stator 50 while flange member 209 constrains stator 50 in the axial direction.

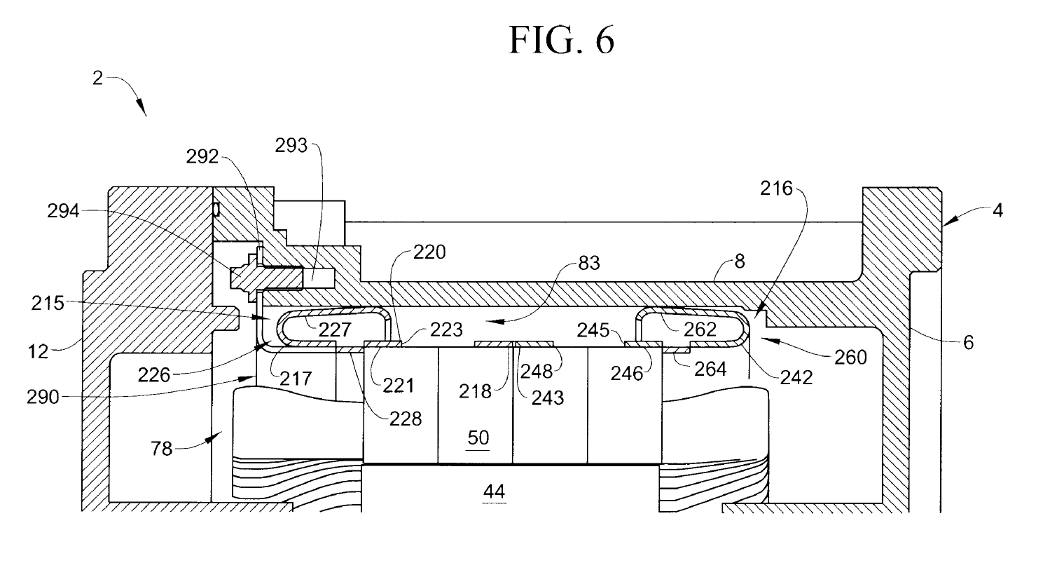

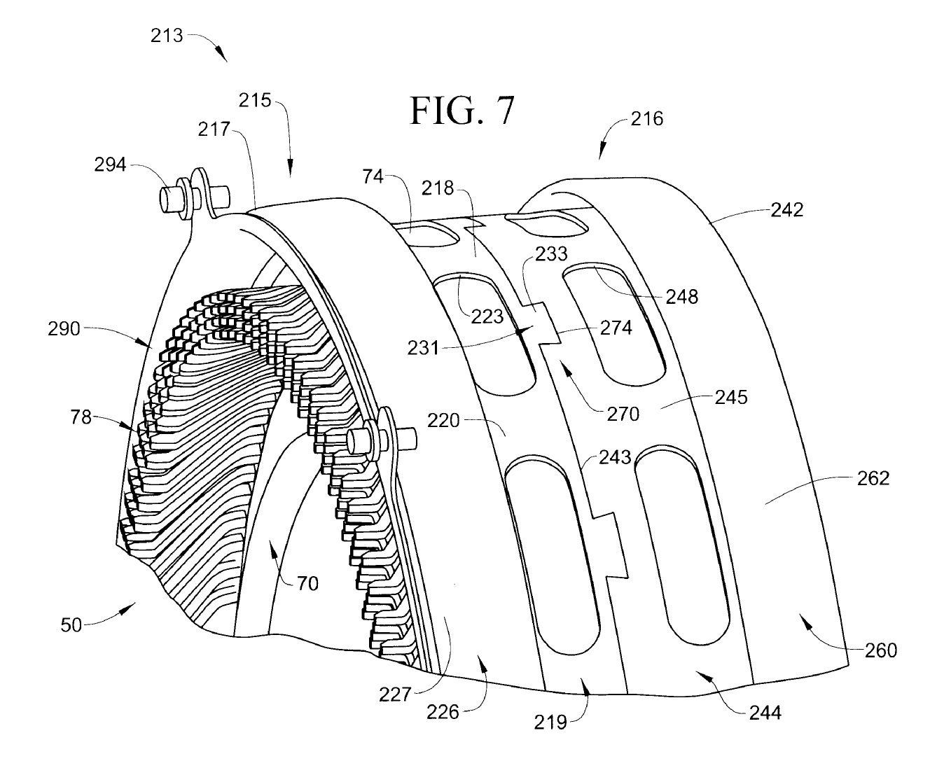

Reference will now be made to FIGS. 6-7, wherein like reference numbers represent corresponding parts in the respective views in describing a stator sleeve 213 constructed in accordance with another aspect of the exemplary embodiment. Stator sleeve 213 includes a first sleeve portion 215 and a second sleeve portion 216. First sleeve portion 215 includes a first diametric edge 217 that extends to a second diametric edge 218 through an intermediate portion 219 Intermediate portion 219 includes an outer diametric surface 220 and an opposing inner diametric surface 221. Intermediate portion 219 is also shown to include a plurality of openings, one of which is indicated at 223, that facilitate contact between coolant (not shown) passing through coolant cavity 83 and body member 70. First sleeve portion 215 includes an interface member 226 that extends from outer diametric surface 220 at first diametric edge 217. Interface member 226 includes a cantilevered section 227 that establishes a resilient interface between stator 50 and housing 4. First sleeve portion 215 is also shown to include a locating member 228. Locating member 228 takes the form of a shoulder (not separately labeled) formed in inner diametric surface 221 that establishes a desired position of first sleeve portion 215 relative to stator 50. First sleeve portion 215 is further shown to include a mounting member 231 which, in the exemplary aspect shown, takes the form of a tab member 233. In a manner similar to that described above, mounting member 231 provides an interface to second sleeve portion 216.

Second sleeve portion 216 includes a first diametric edge section 242 that extends to a second diametric edge section 243 through an intermediate section 244. Intermediate section 244 includes an outer diametric surface 245 and an opposing inner diametric surface 246. Intermediate section 244 is also shown to include a plurality of openings, one of which is indicated at 248, that facilitate contact between coolant (not shown) passing through coolant cavity 83 and body member 70. Second sleeve portion 216 includes an interface member 260 that extends from outer diametric surface 245 at first diametric edge 242. Interface member 260 includes a cantilevered section 262 that establishes a resilient interface between stator 50 and housing 4. Second sleeve portion 216 is also shown to include a locating element 264. Locating element 264 takes the form of a shoulder (not separately labeled) formed in inner diametric surface 246 that establishes a desired position of second sleeve portion 240 relative to stator 50. Second sleeve portion 216 is also shown to include a mounting element 270 that takes the form of a notch element 274.

Notch element 274 interfaces/interlocks with tab member 233 to provide an interface between first and second sleeve portions 215 and 216. In a manner similar to that described above, first sleeve portion 215 is mounted to stator 50 such as by an interference fit with outer perimetric surface 74 of body member 70. Once first sleeve portion 215 is seated with locating member 228 abutting body member 70, second sleeve portion 216 is mounted to stator 50. Second sleeve portion 216 is also secured through, for example, an interference fit with outer perimetric surface 74 of body member 70. When second sleeve portion 216 is fully seated with locating element 264 abutting body member 70, tab member 233 interlocks with notch element 274. Once interlocked first sleeve portion 215 and second sleeve portion 216 are joined without the need for additional mechanical fasteners. Once stator sleeve 213 is mounted, stator 50 is installed into interior portion 10. When installed, interface members 226 and 260 exert a substantially uniform radial force that establishes a desired position of stator 50 relative to housing 4. In the exemplary embodiment shown, interface members 226 and 260 resiliently bias stator 50 toward a center of housing 4. Interface member 226 and 260 also create coolant cavity 83. At this point, a flange member 290 is positioned within first sleeve portion 215 and secured to housing 4. Flange member 290 includes a plurality of mounting sections, one of which is indicated at 292, which align with corresponding mounting portions, such as shown at 293 in FIG. 6, and secured by mechanical fasteners 294. With this arrangement, stator sleeve 213 establishes a radial position of stator 50 while flange member 290 constrains stator 50 in the axial direction.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electric machine comprising:
a housing;
a stator mounted within the housing, the stator including an outer perimetric surface and an inner perimetric surface;
a rotor mounted, at least in part, within the inner perimetric surface of the stator, the rotor being rotatable relative to the stator; and
a stator sleeve extending about the stator, the stator sleeve including a first sleeve portion and a second sleeve portion, the first sleeve portion including a first diametric edge that extends to a second diametric edge, and the second sleeve portion including a first diametric edge section that extends to a second diametric edge section, the stator sleeve being configured and disposed to establish a coolant cavity about the outer perimetric surface of the stator.

2. The electric machine according to claim 1, wherein the stator sleeve includes an outer diametric surface and an inner diametric surface, the outer diametric surface including at least one interface member that engages with the housing, the at least one interface member establishing a particular position of the stator relative to the housing.

3. The electric machine according to claim 2, wherein the at least one interface member includes a cantilevered section that extends about the outer diametric surface of the stator sleeve.

4. The electric machine according to claim 1, further comprising: a flange member mounted to the stator sleeve, the flange member being secured to the housing.

5. The electric machine according to claim 4, wherein the flange member is secured to the housing along an axial axis of the electric machine.

6. The electric machine according to claim 1, wherein the stator sleeve includes a plurality of openings that extend between the stator and the coolant cavity.

7. The electric machine according to claim 1, wherein the first sleeve portion includes at least one mounting member provided on the second diametric edge, and the second sleeve portion includes at least one mounting element provided on the second diametric edge section, the at least one mounting member engaging with the at least one mounting element to join the first and second sleeve portions.

8. The electric machine according to claim 7, wherein the at least one mounting member comprises the second diametric edge and the at least one mounting element comprises a flange formed on the second diametric edge section.

9. The electric machine according to claim 7, wherein the at least one mounting member comprises a flange member formed on the second diametric edge and the at least one mounting element comprises a flange element formed on the second diametric edge section, the flange member being joined to the flange element through a plurality of mechanical fasteners.

10. The electric machine according to claim 7, wherein the at least one mounting member comprises at least one tab member formed on the second diametric edge and the at least one mounting element comprises at least one notch element formed on the second diametric edge section, the at least one tab member interlocking with the at least one notch element to join the first sleeve portion to the second sleeve portion.

11. The electric machine according to claim 7, wherein the first sleeve portion includes a inner diametric surface having a locating member, and the second sleeve portion including an inner diametric surface having a locating element, the locating member and the locating element engaging with the stator to establish a particular position of the stator sleeve relative to the stator.

12. A method of forming a coolant cavity about a stator of an electric machine, the method comprising:
mounting a stator sleeve including a first sleeve portion and a second sleeve portion about an outer perimetric surface of a stator;
inserting the stator sleeve into an interior portion of an electric machine housing; and
establishing a coolant cavity about an outer perimetric surface of the stator between the stator sleeve and the housing.

13. The method of claim 12, further comprising: forming a substantially uniform radial force between the stator sleeve and the electric machine housing to center the stator within the interior portion.

14. The method of claim 13, wherein forming the substantially uniform radial force between the stator sleeve and the housing comprises resiliently biasing the stator towards a center of the interior portion of the electric machine housing.

15. The method of claim 12, further comprising: joining the first sleeve portion to the second sleeve portion.

16. The method of claim 15, wherein joining the first sleeve portion to the second sleeve portion includes fastening the first sleeve portion to the second sleeve portion.

17. The method of claim 15, wherein joining the first sleeve portion to the second sleeve portion includes interlocking the first sleeve portion to the second sleeve portion.

18. The method of claim 12, further comprising: installing a flange member to one of the first and second sleeve portions.

19. The method of claim 18, further comprising: aligning a plurality of mounting sections provided on the flange member with a plurality of mounting portions provided on the electric machine housing.

20. The method of claim 19, further comprising: securing the mounting sections to the mounting portions to fixedly retain the stator sleeve to the electric machine housing along an axial axis.
